(19) United States
(12) Patent Application Publication
(10) Pub. No.: US 2004/0236585 A1
(43) Pub. Date: Nov. 25, 2004

(54) Optical media repair method and optical media mailer therefor

(76) Inventors: Ryan Kohnke, Chandler, AZ (US); Chad Seayerns, Scottsdale, AZ (US); Mark Colletti, Tempe, AZ (US)

Correspondence Address: WEISS & MOY PC, 4204 NORTH BROWN AVENUE, SCOTTSDALE, AZ, 85251, US

(21) Appl. No.: 10/441,706

(22) Filed: May 20, 2003

(51) Int. Cl. G06F 17/60

(52) U.S. Cl. 705/1

(57) ABSTRACT

An optical media repair method, business method and optical media mailer therefor allows customers to place damaged optical media discs into an optical media mailer which is subsequently delivered to an optical media repair center where the optical media is repaired and then returned to the customer in the optical media mailer.

### FIELD OF THE INVENTION

This invention relates generally to optical media and, more particularly, to a method for doing business relating to optical media repair, a method of optical media repair, and an optical media mailer therefor in which damaged optical media is placed in an optical media mailer and delivered to an optical media repair center, where the optical media is repaired and then returned in the optical media mailer.

### BACKGROUND OF THE INVENTION

Optical media has become the standard format for music (in the form of compact discs (CD's)), movies (digital movie discs (DVD's)) and video games. Even business cards, photos and other information is being converted to optical media because of its high storage capacity and lightweight design, among other reasons. As a result of the popularity of the optical media format, more than 50 billion CD's, DVD's and video games have been produced in the last decade alone. Most video game machines, such as Playstation and X-Box, have adopted the optical media format, issuing all new games on optical media discs.

Optical media discs are typically constructed of four layers. The first layer is the plastic or polycarbonate disc. Data is burned or stamped into the polycarbonate, typically on the top side. On recordable optical media discs, however, data can be burned in to different levels of the polycarbonate disc. The second layer is a reflective foil layer, most commonly a very thin layer of aluminum (although copper, silver and gold are used for higher quality discs). In order for the data to be read, a laser bounces a beam off of the foil layer and back through the data of the polycarbonate disc. The third layer usually consists of a lacquer that is applied to the disc in order to create a thin layer of sealant for the foil layer. This third layer or sealant, although sealing the foil layer, does not significantly protect the data of the polycarbonate layer. Finally, graphics or print of some kind are often screened onto the lacquer layer, although recordable CDs do not always have this fourth layer.

The construction and use of optical media discs suffer from several major drawbacks. Because a laser is used to read the data, scratches, gouges, stains, scrapes or other significant damage to the bottom or top surface of the disc can cause the laser beam to refract. If the laser beam is unable to beam directly through the plastic to reach the data of the foil layer and back again, the data will not be properly read. This can translate into skipping, freezing, other technical difficulties, or at worst, a loss of data.

In addition to the damage caused by typical wear and tear, optical media discs can also become scratched or damaged inside an optical media reading device, such as a video game station, CD player or DVD player, by the laser itself or by the disc tray. The overall fragility of optical media has resulted in a tremendous loss of revenue by stores renting DVD's and video games, as well as stores selling used CD's and other optical media. When discs become damaged, they must be removed from the shelf and refunds are typically issued. Optical media repair technology has been developed to repair damaged discs. The most common form of repair involves resurfacing the plastic disc by grinding out the scratches and gouges. Other methods of repair are also available.

Although some hand-operated machines are available to the average consumer, the most successful resurfacing of optical media discs are accomplished by relatively expensive machines. Therefore, most consumers having a damaged CD, DVD or video game must use the services of an optical media repair service in order to have their optical media disc repaired. There are several obstacles, however, which prevent most consumers from utilizing the services of an optical media repair company. First, many consumers are unaware that the technology exists to repair their damaged optical media. Even those with such knowledge often do not have the time to identify an optical media repair company and deliver damaged optical media discs to the company. Such a process requires multiple steps and is time-consuming. Those who wish to mail optical media to a disc repair company often unknowingly cause further damage to their optical media through the packaging and shipping of the discs.

A need therefore existed for an optical media repair business model and method, and optical media mailer therefor capable of: 1) educating consumers about the benefits of optical media repair; 2) providing a simple and secure process for delivering damaged optical media and receiving repaired optical media; and 3) providing an optical media mailer for safely delivering optical media without significant damage thereto.

### SUMMARY OF THE INVENTION

It is an object of the present invention to provide a business method for easily delivering damaged optical media to an optical media repair center and having repaired optical media returned.

It is a further object of the present invention to provide an optical media mailer capable of securely transporting optical media discs without significant damage thereto.

It is a still further object of the present invention to provide an optical media mailer capable of being reused by both a consumer and an optical media repair center.

Other objects, features and advantages of the present invention will become apparent from a consideration of the following detailed description.

### BRIEF DESCRIPTION OF THE PREFERRED EMBODIMENTS

In accordance with one embodiment of the present invention, a method of optical media repair is disclosed, comprising, in combination, the steps of: providing an optical media repair center, providing an optical media mailer, the mailer dimensioned to retain at least one disc, placing at least one disc into the mailer, assigning customer identification indicia to the mailer, the optical media repair center repairing the at least one disc, and returning the at least one disc to a customer.

In accordance with another embodiment of the present invention, an optical media mailer is disclosed, comprising, in combination a disc receiving flap dimensioned to receive at least one optical media disc, and a plurality of flaps coupled to the disc receiving flap and dimensioned to secure the at least one disc to the disc receiving flap, wherein a customer address label being printed on one of the disc receiving flap and the plurality of flaps, wherein a media repair center address being printed on one of the disc receiving flap and the plurality of flaps.

In accordance with yet another embodiment of the present invention a method of doing business is disclosed comprising the step of distributing an optical media mailer dimensioned to receive at least one optical media disc wherein the mailer includes an exchange value associated thereto for a service provided by an optical media repair center.

The foregoing and other objects, features, and advantages of the invention will be apparent from the following, more particular description of the preferred embodiments of the invention, as illustrated in the accompanying drawings.

### BRIEF DESCRIPTION OF THE DRAWINGS

FIG. 1 is a perspective view of the preferred embodiment of the optical media mailer of the present invention, showing the optical media repair center address printed thereon.

FIG. 2 is a bottom view of the preferred embodiment of the optical media mailer of the present invention.

FIG. 3 is a perspective view of a plurality of optical media discs secured in the optical media mailer of the present invention.

FIG. 4 is a perspective view of the preferred embodiment of the optical media mailer of the present invention, showing a first protective flap, a second protective flap, a third protective flap, a fourth protective flap and a fifth protective flap folding over a disc receiving flap for mailing the optical media mailer to an optical media repair center.

FIG. 5 is a perspective view of the optical media mailer of FIG. 4, showing the detachable receipt being detached from the optical media mailer.

FIG. 6 is a perspective view of the preferred embodiment of the optical media mailer of the present invention, showing the first protective flap, the second protective flap, the third protective flap, the fourth protective flap and the fifth protective flap folding over the disc receiving flap for mailing the optical media mailer back to a customer.

FIG. 7 is a perspective view of the optical media mailer of FIG. 6, showing the first protective flap, the second protective flap and the fifth protective flap folded over the disc receiving flap.

FIG. 8 is a perspective view of the optical media mailer of FIG. 7, showing the customer address label of the fourth protective flap being folded over the optical media center address printed of the back surface of the disc receiving flap.

FIG. 9 is a perspective view of one embodiment of the optical media mailer of the present invention, showing the first protective flap, the second protective flap, the third protective flap, and the fourth protective flap folding over the disc receiving flap for mailing the optical media mailer back to a customer.

FIG. 10 is a perspective view flow chart illustrating an embodiment of the method of optical media repair consistent with the present invention.

### DETAILED DESCRIPTION OF THE PREFERRED EMBODIMENTS

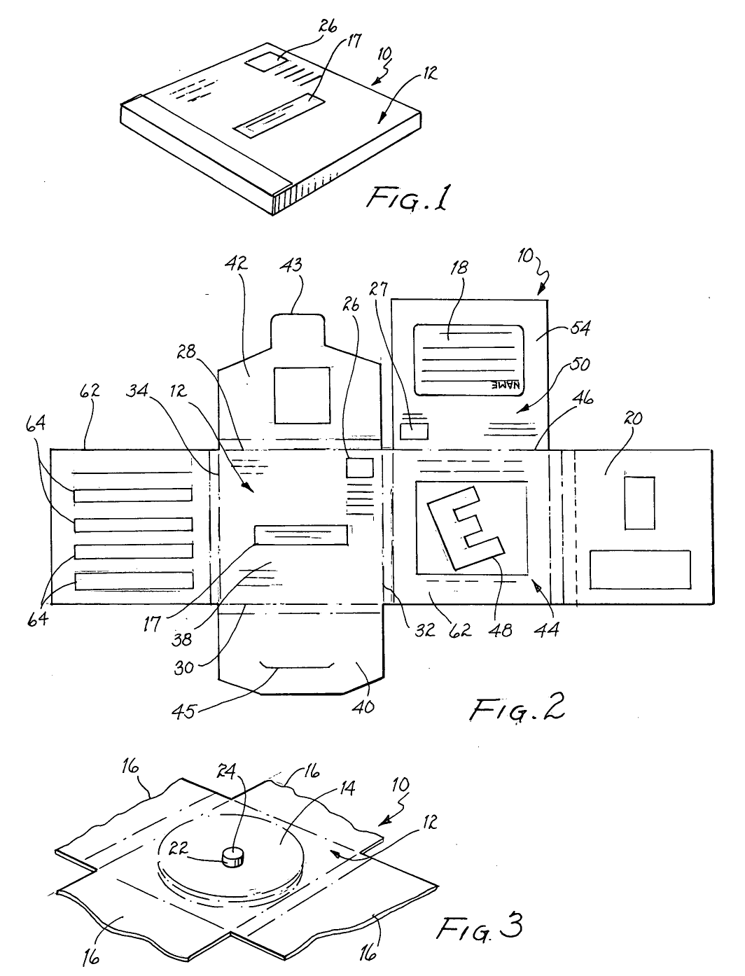

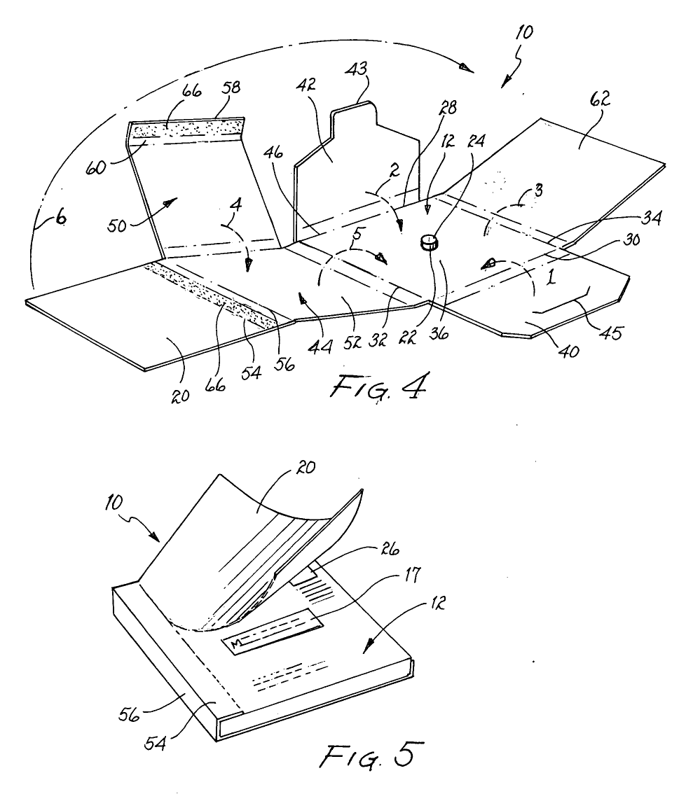

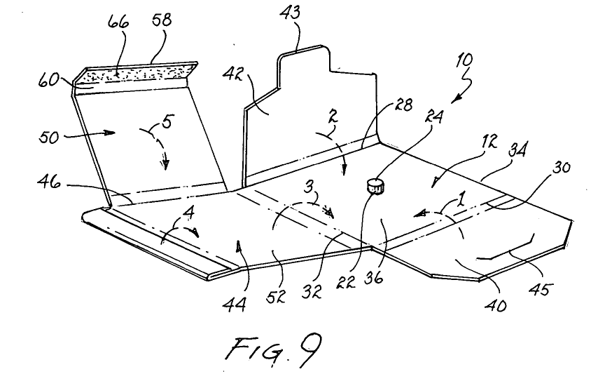

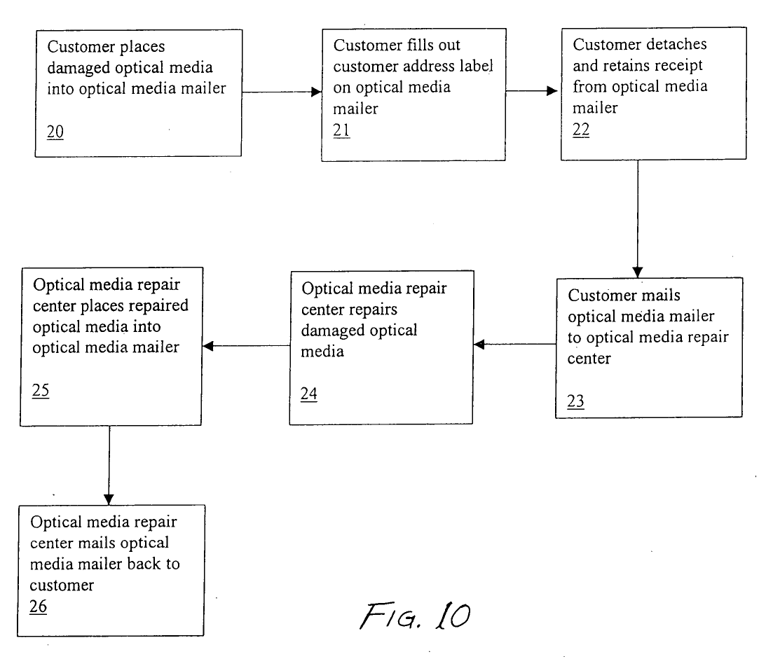

Referring to FIGS. 1-9, an optical media mailer of the present invention, hereinafter optical media mailer 10, is shown. The optical media mailer 10 comprises a disc receiving flap 12 dimensioned to receive at least one optical media disc 14 (shown in FIG. 3). The optical media mailer 10 further comprises a plurality of flaps 16 (shown partially broken away in FIG. 3) coupled to the disc receiving flap 12 and dimensioned to secure the at least one disc 14 to the disc receiving flap 12.

Referring now to FIGS. 1, 2 and 5, a media repair center address 17 is preferably printed on the disc receiving flap 12 so that when the optical media mailer 10 is mailed, the optical media repair center address 17 is visible on an outer portion of the optical media mailer 10. While, in the preferred embodiment, the optical media repair center address 17 is printed on the disc receiving flap 12 it should be clearly understood that substantial benefit could be derived from an alternative embodiment of the optical media mailer 10 in which the media repair center address 17 is printed elsewhere, such as on one of the plurality of flaps 16, so long as the media repair center address 17 is visible on an outer portion of the optical media mailer 10.

Referring now to FIGS. 2 and 8, a customer address label 18 is preferably printed on one of the plurality of flaps 16 so that when the optical media mailer 10 is returned from the media repair center, the customer address label 18 is visible on an outer portion of the optical media mailer 10. While, in the preferred embodiment, the customer address label 18 is printed on one of the plurality of flaps 16 it should be clearly understood that substantial benefit could be derived from an alternative embodiment of the optical media mailer 10 in which the media repair center address 17 is printed elsewhere, such as on the disc receiving flap 12, so long as the customer address label 18 is visible on an outer portion of the optical media mailer 10 after the at least one disc 14 has been repaired and the optical media mailer 10 is being mailed back to a customer.

Referring now to FIGS. 2, 4 and 5, the optical media mailer 10 preferably comprises a receipt 20 detachably coupled to the mailer 10. The receipt allows a customer to maintain a record of the optical media mailer 10, and preferably provides tracking information that the customer can use to track the optical media mailer 10 through a customer service center or through a tracking website available through the internet. While, in the preferred embodiment, the optical media mailer 10 comprises a receipt 20, it should be clearly understood that substantial benefit could be derived from an alternative configuration of the optical media mailer 10 in which there is no receipt 20, or in which the receipt 20 contains no tracking information, and the optical media mailer 10 is simply returned with the at least one disc 14 to the customer address label 18 printed on the optical mailer 10.

Referring now to FIGS. 3, 4, 6 and 9, the optical media mailer 10 preferably further comprises a knob 22 coupled to a center portion of the disc receiving flap 12. The knob 22 is dimensioned to extend through a center aperture defined by an optical media disc 14 so that at least one optical media disc 14 can be securely placed on the disc receiving flap and retained thereto by the knob 22. In the preferred embodiment, the optical media mailer 10 further comprises a cap 24 dimensioned to be coupled to the knob 22 so as to secure at least one optical media disc 14 around the knob 22 and to the disc receiving flap 12. While, in the preferred embodiment, the optical media mailer 10 comprises a knob 22 and a cap 24, it should be clearly understood that substantial benefit could be derived from an alternative configuration of the optical media mailer 10 in which there is only a knob 22 and no cap, or neither a knob 22 or a cap 24, so long as at least one optical media disc 14 can be securely retained by the disc receiving flap 12.

Referring now to FIGS. 1, 2 and 5, preferably the optical media mailer 10 has pre-paid postage 26 printed thereon proximate the optical media repair center address 17 so that a customer can mail the optical media mailer 10 to the optical media repair center without having to apply postage to the optical media mailer 10, although it should be clearly understood that substantial benefit could be derived from an optical media mailer 10 which lacks pre-paid postage 26. For example, it is within the spirit and scope of this invention that a retail outlet may collect multiple optical media mailers 10 and transport them physically or by mail in a larger container, negating the need for pre-paid postage or postage of any kind to be placed on the optical media mailer 10.

Referring now to FIGS. 2-8, preferably the optical media mailer 10 has pre-paid postage 27 printed thereon proximate the customer address label 18 so that the optical media repair center can mail the optical media mailer 10 to the customer without having to apply postage to the optical media mailer 10, although it should be clearly understood that substantial benefit could be derived from an optical media mailer 10 which lacks pre-paid postage 27. For example, it is within the spirit and scope of this invention that the optical media repair center may deliver multiple optical media mailers 10 to a retail outlet (for subsequent delivery to the customer by the retail outlet) physically or by mail in a larger container, negating the need for pre-paid postage or postage of any kind to be placed on the optical media mailer 10.

In the preferred embodiment, the optical media mailer 10 is reusable so that a customer can use the optical media mailer 10 in order to deliver at least one optical media disc 14 to an optical media repair center for repair, and the optical media repair center can then use the same optical media mailer 10 to return the at least one optical disc 14 to the customer. Preferably, the optical media mailer 10 is comprised substantially of chipboard, although it should be clearly understood that substantial benefit could be derived from another material, such as plastic, cardboard or thick paper, so long as the optical media mailer 10 can securely retain at least one optical media disc 14.

In the preferred embodiment, the optical media mailer 10 is color-coded, with each color corresponding to a separate quantity of optical media discs 14 to be placed in the optical media mailer 10. Preferably, a first color corresponds to an optical media mailer 10 for one optical media disc 14, a second color corresponds to an optical media mailer 10 for three optical media discs 14 and a third color corresponds to an optical media mailer 10 for five optical media discs 14. It should be clearly understood that deviations in the preferred number of colors or quantities is within the spirit and scope of this invention. While, in the preferred embodiment, the optical media mailer 10 is color-coded, it should be clearly understood that substantial benefit could be derived from an alternative embodiment of the optical media mailer 10 in which there is no color-coding.

Referring now to FIGS. 2, 4 and 6-9, a preferred embodiment of the optical media mailer 10 is shown. The disc receiving flap 12 preferably comprises a top edge 28 (shown in FIGS. 2, 4, 6, and 9), a bottom edge 30, a first side edge 32, a second side edge 34 (shown in FIGS. 2, 4, 6, 8 and 9), a front disc receiving surface 36 (shown in FIGS. 4, 6 and 9) and a back surface 38 (shown in FIGS. 2 and 8). The back surface 38 of the disc receiving flap 12 preferably has an optical media repair center address 17 printed thereon. The front disc receiving surface 36 is dimensioned to receive at least one optical media disc 14.

Referring now to FIGS. 2, 4, 6, and 9, the optical media mailer 10 preferably further comprises a first protective flap 40 coupled to the bottom edge 30 of the disc receiving flap 12. The first protective flap 40 is dimensioned to be folded over a portion of the at least one disc 14. The optical media mailer 10 preferably further comprises a second protective flap 42 coupled to the top edge 28 of the disc receiving flap 12. The second protective flap 42 is dimensioned to be folded over a portion of the at least one disc 14. In the preferred embodiment, the second protective flap 42 defines a tab 43 dimensioned to be coupled to a slot 45 defined by the first protective flap 40 when the first protective flap 40 and the second protective flap 42 are folded over a portion of the at least one disc 14, although it should be clearly understood that substantial benefit could be derived from an alternative configuration of the optical media mailer 10 in which there is no tab 43 or slot 45, or in which some other securing mechanism is used, so long as the at least one optical media disc 14 is securely retained within the optical media mailer 10.

Referring now to FIGS. 2, 4, 6, 7 and 9, the optical media mailer 10 preferably further comprises a third protective flap 44 coupled to the first side edge 32 of the disc receiving flap 12. The third protective flap 44 is dimensioned to be folded over the first protective flap 40 and the second protective flap 42 after the first protective flap 40 and the second protective flap 42 have been folded over the at least one disc 14. In the preferred embodiment, the optical media mailer 10 comprises a video game rating 48 (shown in FIG. 2), such as “E” for everyone. Video games are often rated, based on content, for different age groups. The rating “E”, for everyone, indicates that the video game is appropriate for all age groups. Placing an “E” rating on the optical media mailer 10 will serve to educate customers that the optical media mailer 10 is a product suitable for all ages and all types of video games. While, in the preferred embodiment, the optical media mailer 10 comprises a video game rating 48, it should be clearly understood that substantial benefit could be derived from an alternative embodiment of the optical media mailer 10 in which there is no video game rating 48, or in which other information is provided in this area, or in which separate video game ratings 48 are given for individual optical media mailers 10.

Referring now to FIGS. 2, 4, and 6-9, the optical media mailer 10 preferably further comprises a fourth protective flap 50 coupled to the third protective flap 44. Preferably, the customer address label 18 is printed on a back surface 54 (shown in FIGS. 2 and 8) of the fourth protective flap 50. The fourth protective flap 50 is dimensioned to be folded over either a front surface 52 (shown in FIGS. 4, 6, 7 and 9) of the third protective flap 44 or the back surface 38 of the disc receiving flap 12. Preferably, after at least one damaged optical media disc 14 is securely placed on the disc receiving flap 12, the first flap 40 and the second flap 42 are folded over the at least one disc 14. The fourth protective flap 50 is then preferably folded over the front surface 52 of the third protective flap 44. Then, the third protective flap 44 and the fourth protective flap 50 are folded over the first protective flap 40 and the second protective flap 42. After the optical media repair center repairs said at least one disc, the fourth protective flap 50 is preferably folded over the back surface 38 of the disc receiving flap 12 so that the customer address label 18 covers the optical media repair center address 17 in order for the optical media mailer 10 to be mailed back to a customer.

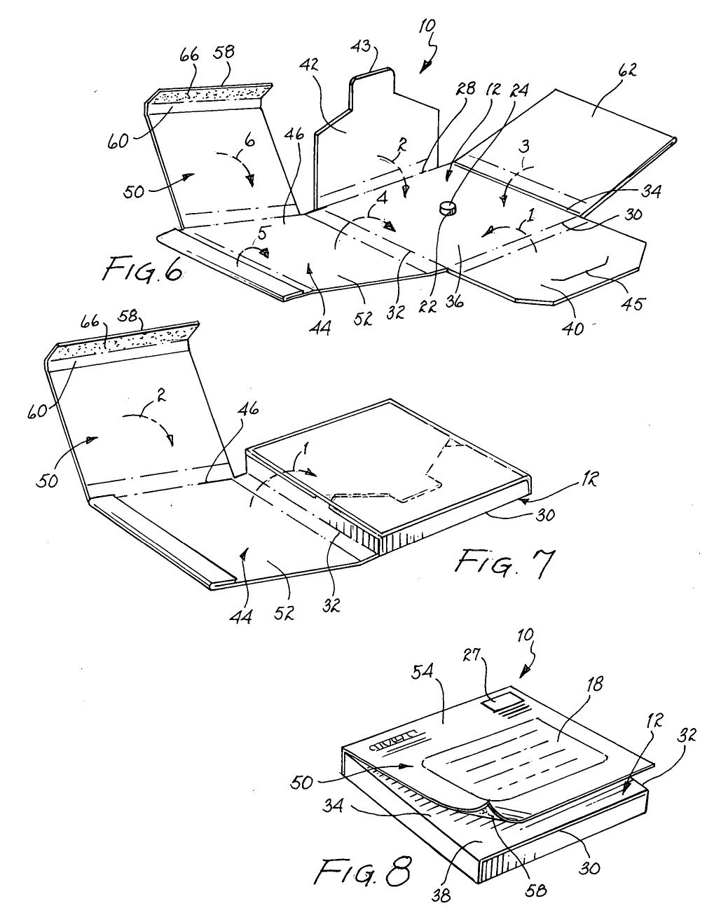

Referring now to FIGS. 4-5, the optical media mailer 10 preferably further comprises a first securing flap 54 coupled to a side edge 56 of the third protective flap 44. The first securing flap 54 is dimensioned to couple the side edge 56 of the third protective flap 44 to a portion of the back surface 38 of the disc receiving flap 12. Thus, after a damaged optical media disc 14 is placed into the disc receiving flap 12, and after all of the other flaps are folded over the at least one disc 14, the optical media mailer 10 is preferably securely closed by the first securing flap 54. Preferably, the first securing flap 54 comprises a first adhesive strip 66 (shown in FIG. 4) having a tacky surface and a removable backing strip so that a person could peel away the backing strip to expose the tacky surface prior to coupling the side edge 56 of the third protective flap 44 to a portion of the back surface 38 of the disc receiving flap 12, although it should be clearly understood that substantial benefit could be derived from an alternative configuration of the first securing flap 54 in which there is no adhesive strip 66, such as by using tabs and slots, so long as the first securing flap 54 can be securely coupled to the back surface 38 of the disc receiving flap 12.

Referring now to FIGS. 4, and 6-9, the optical media mailer 10 preferably further comprises a second securing flap 58 coupled to a top edge 60 (shown in FIGS. 4, 6, 7 and 9) of the fourth protective flap 50. The second securing flap 58 is dimensioned to couple the top edge 60 of the fourth protective flap 50 to a portion of a back surface 62 (shown in FIG. 2) of the third protective flap 44. Thus, after a repaired optical media disc 14 is placed back into the disc receiving flap 12, and after all of the other flaps are folded over the at least one disc 14, the optical media mailer 10 is preferably securely closed by the second securing flap 58 so that the customer address label 18 covers the optical media repair center address 17 in order for the optical media mailer 10 to be mailed from the optical media repair center back to the customer. Preferably, the second securing flap 58 comprises a second adhesive strip 68 (shown in FIGS. 4, 6, 7 and 9) having a tacky surface and a removable backing strip so that a person could peel away the backing strip to expose the tacky surface prior to coupling the second securing flap 58 to a portion of the back surface 62 of the third protective flap 44, although it should be clearly understood that substantial benefit could be derived from an alternative configuration of the second securing flap 58 in which there is no adhesive strip 68, so long as the second securing flap 58 can be securely coupled to the back surface 38 of the disc receiving flap 12.

Referring now to FIGS. 2, 4 and 6, the optical media mailer 10 preferably further comprises a fifth protective flap 62 coupled to the second side edge 34 of the disc receiving flap 12. The fifth protective flap is dimensioned to be folded over the first protective flap 40 and the second protective flap 42 after they have been folded over the front surface 36 of the disc receiving flap 12. One purpose for the fifth protective flap 62 is to serve as an extra form of protection for the at least one optical media disc 14. Preferably, the fifth protective flap 62 also provides information 64 (shown in FIG. 2) to educate potential customers on the optical media repair process, frequently asked questions, different types of optical media damage, how to identify optical media damage, etc. It is also within the spirit and scope of this invention that the fifth protective flap 62 provide advertising information.

While, in the preferred embodiment, the optical media mailer 10 comprises a first protective flap 40, a second protective flap 42, a third protective flap 44, a fourth protective flap 50, a fifth protective flap 62, a first securing flap 54, and a second securing flap 58 it should be clearly understood that substantial benefit could be derived form an alternative configuration of the optical media mailer 10 in which these flaps are arranged in a different configuration, or in which the optical media mailer 10 lack these flaps altogether, so long as the optical media mailer 10 can securely retain at least one optical media disc 14.

Referring now to FIG. 10, a method in accordance with an embodiment of optical media repair of the present invention will be illustrated by a description of its operation. Initially, a customer places damaged optical media (typically in the form of an optical media disc) into an optical media mailer (step 20). The optical media mailer may be: 1) purchased by the customer at a retail outlet; 2) purchased directly from an optical media repair center; 3) received as part of an optical media system, such as a video game system, DVD player, CD player, etc.; or 4) acquired in some other fashion. The customer fills out a customer address label with the customer's address on the optical media mailer (step 21). In the preferred embodiment, the customer detaches and retains a receipt from the optical media mailer (step 22). Preferably, the receipt also contains tracking information that allows the customer to track the progress of the optical media repair by contacting a customer service center or online through a tracking service on a website. The customer then mails the optical media mailer to the optical media repair center (step 23) with the optical media repair address visible on an outer portion of the optical media mailer. After receiving the damaged optical media, the optical media repair center repairs the damaged optical media (step 24). After repair is completed, the optical media repair center places the repaired optical media into the optical media mailer (step 25). The optical media repair center then mails the optical media mailer back to the customer (step 26).

A business method in accordance with an embodiment of the invention includes an optical media mailer 10 dimensioned to receive at least one disc 14, wherein the mailer 10 includes an exchange value associated thereto for a service to be provided by an optical media repair center in accordance with the above-described methods. For example, the mailer 10 may not be mailed, but rather collected by a retail outlet and subsequently delivered to an optical media repair center. The retail outlet or a customer could mark the mailer 10 with customer identification indicia (such as a membership number), and after receiving the mailer back from the optical media repair center, the retail outlet could return the mailer 10 to the customer, or the customer could pick up the mailer 10 at the retail outlet or some other location. Additionally, the mailer 10 may be purchased or received as a promotion or part of an optical media system, such as a video game system, DVD player or CD player.

While the invention has been particularly shown and described with reference to preferred embodiments thereof, it will be understood by those skilled in the art that the foregoing and other changes in form and details may be made therein without departing from the spirit and scope of the invention.

We claim:

1. A method of optical media repair comprising, in combination, the steps of:
providing an optical media repair center;
providing an optical media mailer, said mailer dimensioned to retain at least one disc;
placing at least one disc into said mailer;
assigning customer identification indicia to said mailer;
said optical media repair center repairing said at least one disc; and
returning said at least one disc to a customer.

2. The method of claim 1 wherein said mailer having an optical media repair center address printed thereon.

3. The method of claim 2 wherein said mailer having pre-paid postage thereon proximate said optical media repair center address.

4. The method of claim 1 further comprising the step of a customer inputting a customer address onto a customer address label printed on said mailer.

5. The method of claim 4 wherein said mailer having pre-paid postage thereon proximate said customer address label.

6. The method of claim 4 further comprising the steps of:
said optical media repair center inserting said at least one disc into said mailer; and
said optical media repair center mailing said mailer back to said customer with said customer address label on an outer portion of said mailer.

7. The method of claim 1 wherein said mailer being reusable.

8. The method of claim 1 further comprising the steps of:
providing a customer support center;
said customer contacting said customer support center with questions regarding at least one of: optical media repair, said optical media repair center, location of a retail facility having optical media repair center products, product ordering information and status of optical media repair of said at least one disc of said customer; and
said customer support center providing said customer with information concerning at least one of: said optical media repair center, optical media repair technology, status of optical media repair of said at least one disc of said customer, location of a retail facility having optical media repair center products, and product ordering information.

9. The method of claim 8 wherein said customer support center is telephone-based and said customer contacts said customer support center by telephone.

10. The method of claim 8 further comprising the steps of:
said customer requesting information concerning at least one of: said optical media repair center, optical media repair technology, status of optical media repair of said at least one disc of said customer, location of a retail facility having optical media repair center products, and product ordering information;
said customer support center providing said information in response to said request from said customer through a browser connected to the internet.

11. The method of claim 1 further comprising the steps of:
providing a receipt detachably coupled to said mailer;
said customer detaching said receipt from said mailer prior to mailing said mailer.

12. The method of claim 11 wherein said receipt includes tracking information for said mailer.

13. The method of claim 1 further comprising the step of said customer purchasing said mailer from a retail outlet.

14. The method of claim 13 wherein said retail outlet assigns customer identification indicia to said mailer.

15. The method of claim 13 further comprising the step of said retail outlet delivering said mailer to said optical media repair center.

16. The method of claim 1 further comprising the step of said customer purchasing said mailer from said optical media repair center.

17. The method of claim 1 further comprising the step of providing an optical media system, said mailer being packaged with said optical media system.

18. The method of claim 1 wherein said mailer being color-coded, each color corresponding to a separate quantity of optical media discs to be placed in said mailer.

19. The method of claim 18 wherein a first color corresponds to a mailer for one optical media disc, and wherein a second color corresponds to a mailer for three optical media discs and wherein a third color corresponds to a mailer for five optical media discs.

20. The method of claim 1 wherein said mailer comprises:
a disc receiving flap; and
a plurality of flaps coupled to said disc receiving flap and dimensioned to secure said at least one disc to said disc receiving flap;
a customer address label printed on one of said disc receiving flap and said plurality of flaps; and
a media repair center address printed on one of said disc receiving flap and said plurality of flaps.

21. The method of claim 1 further comprising the steps of:
providing a disc receiving flap having a top edge and a bottom edge and a first side edge and a second side edge and a front disc receiving surface and a back surface, said back surface of said disc receiving flap having an optical media repair center address printed thereon;
said customer placing at least one disc on said front disc receiving surface of said disc receiving flap;
providing a first protective flap coupled to said bottom edge of said disc receiving flap;
said customer folding said first protective flap over a portion of said at least one disc;
providing a second protective flap coupled to said top edge of said disc receiving flap;
said customer folding said second protective flap over a portion of said at least one disc;
providing a third protective flap coupled to said first side edge of said disc receiving flap;
providing a fourth protective flap coupled to said third protective flap, a back surface of said fourth protective flap having a customer address label printed thereon;
said customer folding said fourth protective flap over said front surface of said third protective flap;
said customer folding said third protective flap and fourth protective flap over said first protective flap and said second protective flap;
providing a first securing flap coupled to a side edge of said third protective flap; and
said customer coupling said first securing flap to a portion of said back surface of said disc receiving flap;
wherein said disc receiving flap, said first protective flap, said second protective flap, said third protective flap, said fourth protective flap, and said first securing flap together comprise said mailer.

22. The method of claim 21 further comprising the steps of:
providing a second securing flap coupled to a top edge of said fourth protective flap;
said optical media repair center folding said fourth protective flap over said back surface of said disc receiving flap so that said customer address label covers said optical media repair center address of said back surface of said disc receiving flap;
said optical media repair center coupling said second securing flap to a portion of said back surface of said third protective flap; and
said optical media repair center mailing said mailer back to said customer.

23. The method of claim 21 further comprising the steps of:
providing a receipt detachably coupled to said first side edge of said second securing flap; and
said customer detaching said receipt from said second securing flap prior to mailing said mailer.

24. The method of claim 23 further comprising the step of said customer tracking said mailer with tracking information included on said receipt.

25. The method of claim 21 further comprising the steps of:
providing a fifth protective flap coupled to said second side edge of said disc receiving flap; and
said customer folding said fifth protective flap over said first protective flap and said second protective flap before said third protective flap is folded over said first protective flap and said second protective flap.

26. The method of claim 21 further comprising the steps of:
providing a knob coupled to a center portion of said front disc receiving surface of said disc receiving flap, said knob dimensioned to extend through a center aperture defined by an optical media disc; and
said customer inserting said knob through said at least one disc.

27. The method of claim 26 further comprising the steps of:
providing a cap;
said customer securing said at least one disc to said front disc receiving surface of said disc receiving flap by coupling said cap to said knob with said at least one disc therebetween.

28. The method of claim 21 further comprising the step of said customer inserting a tab defined by said second protective flap into a slot defined by said first protective flap in order to secure said first protective flap and said second protective flap over said at least one disc.

29. The method of claim 22 further comprising the steps of:
providing a first adhesive strip coupled to a front surface of said first securing flap, said first adhesive strip comprising:
a tacky surface for coupling said first securing flap to a portion of a back surface of said third protective flap; and
a removable backing strip, said backing strip being attached to said tacky surface of said first adhesive strip so as to protect said tacky surface prior to use of said tacky surface; and
said customer removing said backing strip from said first adhesive strip; and
said customer coupling said first securing flap to a portion of said back surface of said disc receiving flap after inserting said at least one disc into said mailer for mailing to said optical media repair center; and
providing a second adhesive strip coupled to a front surface of said second securing flap; said second adhesive strip comprising:
a tacky surface for coupling said second securing flap to a portion of said back surface of said disc receiving flap; and
a removable backing strip, said backing strip being attached to said tacky surface of said second adhesive strip so as to protect said tacky surface prior to use of said tacky surface;
said optical media repair center removing said backing strip from said second adhesive strip; and
said optical media repair center coupling said second securing flap to a portion of said back surface of said disc receiving flap after repairing said at least one disc and after inserting said at least one disc into said mailer for return mailing to said customer so that said customer address label covers said optical media repair center address.

30. An optical media mailer comprising, in combination:
a disc receiving flap dimensioned to receive at least one optical media disc; and
a plurality of flaps coupled to said disc receiving flap and dimensioned to secure said at least one disc to said disc receiving flap;
wherein a customer address label being printed on one of said disc receiving flap and said plurality of flaps;
wherein a media repair center address being printed on one of said disc receiving flap and said plurality of flaps.

31. The optical media mailer of claim 30 further comprising a receipt detachably coupled to said mailer.

32. The optical media mailer of claim 31 wherein said receipt having tracking information printed thereon.

33. The optical media mailer of claim 30 further comprising a knob coupled to a center portion of said disc receiving flap, said knob dimensioned to extend through a center aperture defined by an optical media disc.

34. The optical media mailer of claim 30 further comprising a cap dimensioned to be coupled to said knob, said cap dimensioned to secure said at least one optical media disc around said knob.

35. The optical media mailer of claim 30 wherein said mailer having pre-paid postage printed thereon proximate said media repair center address.

36. The optical media mailer of claim 30 wherein said mailer having pre-paid postage printed thereon proximate said customer address label.

37. The optical media mailer of claim 30 wherein said mailer being reusable.

38. The optical media mailer of claim 30 wherein said mailer being comprised substantially of chipboard.

39. The optical media mailer of claim 30 wherein said mailer being color-coded, each color corresponding to a separate quantity of optical media discs to be placed in said mailer.

40. The optical media mailer of claim 39 wherein a first color corresponds to a mailer for one optical media disc, and wherein a second color corresponds to a mailer for three optical media discs and wherein a third color corresponds to a mailer for five optical media discs.

41. The optical media mailer of claim 30 wherein said mailer comprises:
a disc receiving flap having a top edge and a bottom edge and a first side edge and a second side edge and a front disc receiving surface and a back surface, said back surface of said disc receiving flap having said optical media repair center address printed thereon, said front disc receiving surface of said disc receiving flap dimensioned to receive at least one optical media disc;
a first protective flap coupled to said bottom edge of said disc receiving flap, said first protective flap dimensioned to be folded over a portion of said at least one disc;
a second protective flap coupled to said top edge of said disc receiving flap, said second protective flap dimensioned to be folded over a portion of said at least one disc;
a third protective flap coupled to said first side edge of said disc receiving flap, said third protective flap dimensioned to be folded over said first protective flap and said second protective flap;
a fourth protective flap coupled to said third protective flap, said fourth protective flap dimensioned to be folded over one of a front surface of said third protective flap and said back surface of said disc receiving flap, said customer address label being printed on a back surface of said fourth protective flap;
a first securing flap coupled to a side edge of said third protective flap, said first securing flap dimensioned to couple said side edge of said third protective flap to a portion of said back surface of said disc receiving flap after said first protective flap and said second protective flap having been folded over a portion of said at least one disc and after said fourth protective flap having been folded over a front surface of said third protective flap and after said third protective flap and fourth protective flap having been folded over said first protective flap and said second protective flap so that said mailer can be mailed to said optical media repair center.

42. The optical media mailer of claim 41 further comprising a second securing flap coupled to a top edge of said fourth protective flap, said second securing flap dimensioned to couple said top edge of said fourth protective flap to a portion of a back surface of said third protective flap after said first protective flap and said second protective flap having been folded over a portion of said at least one disc and after said third protective flap having been folded over said first protective flap and said second protective flap and after said fourth protective flap having been folded over said back surface of said disc receiving flap so that said customer address label covers said optical media repair center address in order for said mailer to be mailed from said optical media repair center back to said customer.

43. The optical media mailer of claim 41 further comprising a receipt detachably coupled to a side edge of said first securing flap.

44. The optical media mailer of claim 43 wherein said receipt having tracking information printed thereon.

45. The optical media mailer of claim 41 further comprising a fifth protective flap coupled to said second side edge of said disc receiving flap, said fifth protective flap dimensioned to be folded over said first protective flap and said second protective flap.

46. The optical media mailer of claim 41 wherein said second protective flap defines a tab dimensioned to be coupled to a slot defined by said first protective flap when said first protective flap and said second protective flap being folded over a portion of said disc.

47. The optical media mailer of claim 41 further comprising:
a first adhesive strip coupled to a front surface of said first securing flap, said first adhesive strip comprising:
a tacky surface for coupling said first securing flap to a portion of said back surface of said third protective flap; and
a removable backing strip, said backing strip being attached to said tacky surface of said first adhesive strip so as to protect said tacky surface prior to use of said tacky surface; and
a second adhesive strip coupled to a front surface of said second securing flap; said second adhesive strip comprising:
a tacky surface for coupling said second securing flap to a portion of said back surface of said disc receiving flap; and
a removable backing strip, said backing strip being attached to said tacky surface of said second adhesive strip so as to protect said tacky surface prior to use of said tacky surface.

48. A method of doing business comprising the step of distributing an optical media mailer dimensioned to receive at least one optical media disc wherein said mailer includes an exchange value associated thereto for a service provided by an optical media repair center.

49. The method of claim 48 further comprising the steps of:
placing at least one disc into said mailer;
assigning customer identification indicia to said mailer;
said optical media repair center repairing said at least one disc; and
returning said at least one disc to a customer.

50. The method of claim 48 wherein said mailer having an optical media repair center address printed thereon.

51. The method of claim 50 wherein said mailer having pre-paid postage thereon proximate said optical media repair center address.

52. The method of claim 48 further comprising the step of a customer inputting a customer address onto a customer address label printed on said mailer.

53. The method of claim 52 wherein said mailer having pre-paid postage thereon proximate said customer address label.

54. The method of claim 52 further comprising the steps of:
said optical media repair center inserting said at least one disc into said mailer; and
said optical media repair center mailing said mailer back to said customer with said customer address label on an outer portion of said mailer.

55. The method of claim 48 wherein said mailer being reusable.

56. The method of claim 48 further comprising the steps of:
providing a customer support center;
a customer contacting said customer support center with questions regarding at least one of: optical media repair, said optical media repair center, location of a retail facility having optical media repair center products, product ordering information and status of optical media repair of said at least one disc of said customer; and
said customer support center providing said customer with information concerning at least one of: said optical media repair center, optical media repair technology, status of optical media repair of said at least one disc of said customer, location of a retail facility having optical media repair center products, and product ordering information.

57. The method of claim 56 wherein said customer support center is telephone-based and said customer contacts said customer support center by telephone.

58. The method of claim 56 further comprising the steps of:
said customer requesting information concerning at least one of: said optical media repair center, optical media repair technology, status of optical media repair of said at least one disc of said customer, location of a retail facility having optical media repair center products, and product ordering information;
said customer support center providing said information in response to said request from said customer through a browser connected to the internet.

59. The method of claim 48 further comprising the steps of:
providing a receipt detachably coupled to said mailer;
detaching said receipt from said mailer prior to mailing said mailer.

60. The method of claim 59 wherein said receipt includes tracking information for said mailer.

61. The method of claim 48 further comprising the step of a customer purchasing said mailer from a retail outlet.

62. The method of claim 61 wherein said retail outlet assigns customer identification indicia to said mailer.

63. The method of claim 61 further comprising the step of said retail outlet delivering said mailer to said optical media repair center.

64. The method of claim 48 further comprising the step of a customer purchasing said mailer from said optical media repair center.

65. The method of claim 48 further comprising the step of providing an optical media system, said mailer being packaged with said optical media system.

66. The method of claim 48 wherein said mailer being color-coded, each color corresponding to a separate quantity of optical media discs to be placed in said mailer.

67. The method of claim 66 wherein a first color corresponds to a mailer for one optical media disc, and wherein a second color corresponds to a mailer for three optical media discs and wherein a third color corresponds to a mailer for five optical media discs.
